(19) United States
(12) Patent Application Publication
(10) Pub. No.: US 2011/0201357 A1
(43) Pub. Date: Aug. 18, 2011

(54) METHOD AND SYSTEM FOR REFINING A LOCATION OF A BASE STATION AND/OR A MOBILE DEVICE BASED ON SIGNAL STRENGTH MEASUREMENTS AND CORRESPONDING TRANSMITTER AND/OR RECEIVER ANTENNA PATTERNS

(76) Inventors: David Garrett, Tustin, CA (US); Charles Abraham, Los Gatos, CA (US); Mark Buer, Gilbert, AZ (US); Jeyhan Karaoguz, Irvine, CA (US); David Albert Lundgren, Mill Valley, CA (US); David Murray, Mission Viejo, CA (US)

(21) Appl. No.: 12/748,270

(22) Filed: Mar. 26, 2010

Related U.S. Application Data
(60) Provisional application No. 61/304,085, filed on Feb. 12, 2010.

(51) Int. Cl. H04W 64/00

(52) U.S. Cl. 455/456.2

(57) ABSTRACT

A mobile device receives data transmissions, via a coupled receiver antenna array, from a transmitter antenna array of a serving base station. The mobile device determines relative distances, with respect to the serving base station, associated with signal strength measurements on the received data transmissions. The signal strength measurements are compensated, at the mobile device and/or a remote location server, in three-dimensional space based on corresponding transmitter and/or receiver antenna pattern, and/or mobile orientation information for estimating the relative distances. The estimated relative distances are refined by fitting a function of the azimuth and elevation angles. A location for the serving base station and/or the mobile device is determined or refined based on the refined relative distances to be shared among a plurality of users of the remote location server. Fixed or adaptive antenna patterns are supported at the serving base station and/or the mobile device.

### CROSS-REFERENCE TO RELATED APPLICATIONS/INCORPORATION BY REFERENCE

This patent application makes reference to, claims priority to and claims the benefit from U.S. Provisional Patent Application Ser. No. 61/304,085 filed on Feb. 12, 2010.

This patent application makes reference to:

U.S. Application Ser. No. 61/312,970 filed on Mar. 11, 2010,

U.S. Application Ser. No. 61/303,975 filed on Feb. 12, 2010,

U.S. Application Ser. No. 61/314,521 filed on Mar. 16, 2010,

U.S. application Ser. No. ______ (Attorney Docket No. 21010US02) filed on even date herewith,

U.S. application Ser. No. ______ (Attorney Docket No. 21015US02) filed on even date herewith,

U.S. application Ser. No. ______ (Attorney Docket No. 21018US02) filed on even date herewith, and

U.S. application Ser. No. 12/652,157 filed on Jan. 5, 2010.

Each of the above stated applications is hereby incorporated herein by reference in its entirety.

### FIELD OF THE INVENTION

Certain embodiments of the invention relate to communication systems. More specifically, certain embodiments of the invention relate to a method and system for refining a location of a base station and/or a mobile device based on signal strength measurements and corresponding transmitter and/or receiver antenna pattern.

### BACKGROUND OF THE INVENTION

LBS applications are emerging as a new type of value-added service provided by mobile communication network. LBS are mobile services in which the user location information is used in order to enable various LBS applications such as, for example, enhanced 911 (E-911), location-based 411, location-based messaging and/or location-based friend finding services. A location of a communication device may be determined in different ways such as, for example, using network-based technology, using terminal-based technology, and/or hybrid technology, which is a combination of the former technologies. Many positioning technologies such as, for example, Time of Arrival (TOA), Observed Time Difference of Arrival (OTDOA), Enhanced Observed Time Difference (E-OTD) as well as the Global navigation satellite-based systems (GNSS) such as Global Positioning System (GPS), Global Navigation Satellite System (GLONASS), Galileo, and/or Assisted-GNSS (A-GNSS), may be utilized to estimate the location (latitude and longitude) of the mobile device and convert it into a meaningful X, Y coordinate for Location-Based Services provided via wireless communication systems.

Wireless communication systems may be implemented utilizing various access techniques such as, for example, code division multiple access (CDMA), time division multiple access (TDMA), frequency division multiple access (FDMA), or some other multiple access techniques to communicate services such as LBS to users over communication channels. A communication channel is characterized by fluctuating signal levels and additive interference from in-cell and outer-cells. Signals transmitted over communication channels exhibit co-channel interference and multipath fading, which directly affect the communicated signals and result in time-varying signal quality such as time-varying signal to interference plus noise power ratio (SINR).

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for refining a location of a base station and/or a mobile device based on signal strength measurements and corresponding transmitter and/or receiver antenna pattern, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary communication system that is operable to refine a position or a location of a base station and/or a mobile device based on signal strength measurements and corresponding transmitter and/or receiver antenna pattern, in accordance with an embodiment of the invention.

FIG. 2 is a block diagram illustrating an exemplary mobile device that is operable to refine location information utilizing an adaptive receiver antenna array, in accordance with an embodiment of the invention.

FIG. 3 is a block diagram illustrating an exemplary location server that is operable to refine a location for a base station and/or a mobile device based on signal strength measurements and corresponding transmitter and/or receiver antenna pattern, in accordance with an embodiment of the invention.

FIG. 4 is a flow chart illustrating an exemplary procedure that is utilized by a mobile device to locate a base station utilizing signal strength measurements and corresponding transmitter and/or receiver antenna pattern, in accordance with an embodiment of the invention.

FIG. 5 is a flow chart illustrating an exemplary procedure that is utilized by a location server to locate a base station and/or a mobile device based on signal strength measurements and corresponding transmitter and/or receiver antenna pattern, in accordance with an embodiment of the invention.

### DETAILED DESCRIPTION OF THE INVENTION

Certain embodiments of the invention may be found in a method and system for refining a location of a base station and/or a mobile device based on signal strength measurements and corresponding transmitter and/or receiver antenna pattern. In various embodiments of the invention, a mobile device is operable to receive data transmissions, via a coupled receiver antenna array, from one or more antennas in a transmitter antenna array of a serving base station. The mobile device may be operable to determine relative distances, between the mobile device and the serving base station, associated with signal strength measurements for the received data transmissions. The signal strength measurements may be compensated, at the mobile device and/or a remote location server, in three-dimensional space based on corresponding transmitter and/or receiver antenna pattern, and/or mobile orientation information. The mobile orientation information may comprise information such as, for example, attitude, direction, or heading of the mobile device. Depending on system configuration and/or device capabilities, the transmitter and/or the receiver antenna array may comprise a fixed antenna array and/or an adaptive antenna array. An antenna pattern utilized in a fixed antenna array may be determined based on device type and/or mobile orientation information. An adaptive antenna pattern may be formed via active steering with complex antenna weight vectors that may be estimated dynamically.

The relative distances between the mobile device and the serving base station may be estimated based on the signal strength measurements, the corresponding transmitter and/or receiver antenna pattern, and/or orientation information of the mobile device. The estimated relative distances between the mobile device and the serving base station may be modeled or expressed as a function of the azimuth and elevation angles. In this regard, the signal strength measurements may be utilized to refine the estimated relative distances by fitting to the desired model or function. The accuracy of location information of the serving base station and/or the mobile device may be improved based on the refined relative distances. The refined location information of the serving base station and/or the mobile device may be communicated to the remote location server to support LBS applications. Depending on system configuration, the mobile device may be operable to transmit or communicate to the remote location server with the signal strength measurements, corresponding transmitter and/or receiver antenna pattern, and/or the orientation information of the mobile device. In this regard, the remote location server receives or retrieves signal strength measurements, corresponding transmitter and/or receiver antenna patterns, and/or corresponding mobile orientation information from a plurality of mobile devices in a coverage area served by the serving base station. The received signal strength measurements may be compensated in three-dimensional space based on the received corresponding transmitter and/or receiver antenna patterns, and/or the received corresponding mobile orientation information. The remote location server may be operable to estimate relative distances between each mobile device and the serving base station based on the compensated signal strength measurements. Location information for the serving base station and/or each mobile device may be refined based on the estimated corresponding relative distances whenever needed.

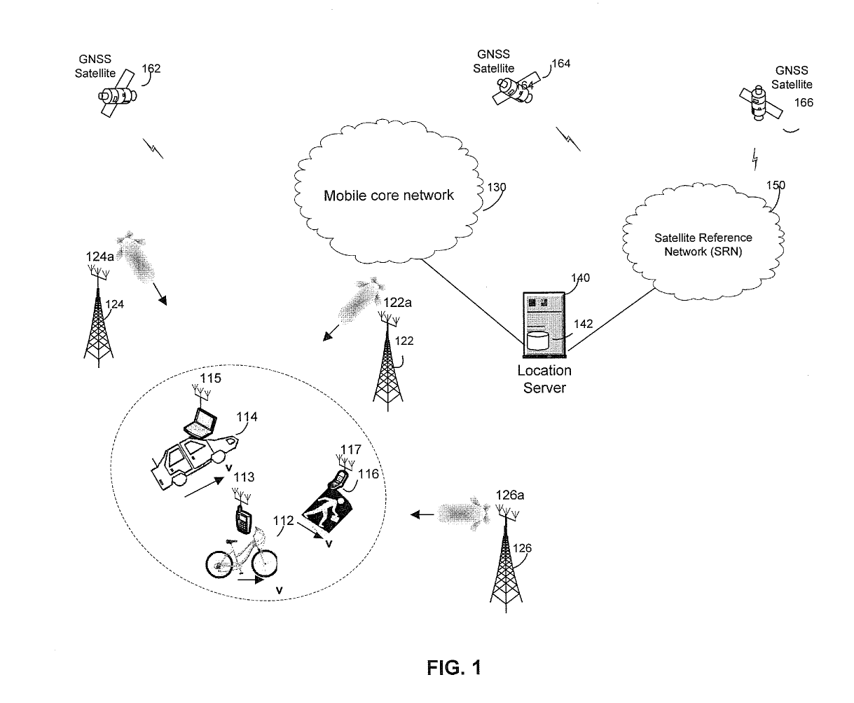

FIG. 1 is a diagram illustrating an exemplary communication system that is operable to refine a position or a location of a base station and/or a mobile device based on signal strength measurements and corresponding transmitter and/or receiver antenna pattern, in accordance with an embodiment of the invention. Referring to FIG. 1, there is shown a communication system 100. The communication system 100 comprises a plurality of mobile devices, of which mobile devices 112-116 are illustrated, a serving base station 122, neighboring base stations 124-126, a mobile core network 130, a location server 140 comprising a reference database 142, a satellite reference network (SRN) 150 and a plurality of GNSS satellites, of which GNSS satellites 162-166 are illustrated. The mobile devices 112-116 are located in a coverage area of the serving base station 122.

A mobile device such as the mobile device 112 may comprise suitable logic, circuitry, interfaces and/or code that are operable to communicate with the mobile core network 130 via the serving base station 122. The mobile device 112 may be operable to transmit and/or receive radio signals over radio channels between the mobile device 112 and the serving base station 122. Radio signals received from the serving base station 122 may comprise data transmissions of services provided by the mobile core network 130. The quality of the data transmissions may vary depending on various channel conditions such as, for example, fluctuating signal strength levels and/or additive interference from neighboring cells.

In instances where the mobile device 112 is moving with a speed of ν within range of the serving base station 122, the mobile device 112 may vary its speed, ν, a moving direction, θ, relative to transmissions to the mobile device 112 from the serving base station 122, as well as the relative distance between the mobile device 112 and the serving base station 122. Signal strength levels measured at the mobile device 112 for the received data transmissions are inversely proportional to the relative distance between the mobile device 112 and the serving base station 122. In this regard, the signal strength measurements at the mobile device 112 for transmissions from the serving base station 122 may indicate how far the serving base station 122 is from the mobile device 112.

The received data transmissions may comprise desired signal components from the serving base station 112 and undesired signal components (interferences) from the neighboring base stations 124-126. In other words, total received signals at the mobile device 112 for data transmissions from the serving base station 122 may be represented as the superimposition of the desired signal components, from the serving base station 122, interferences, from the neighboring base stations 124-126, as well as thermal noise. In instances where the mobile device 112 is moving near the boundary of the coverage area of the serving base station 122, the neighboring base stations 124-126 may cause unacceptable interferences to the reception at the mobile device 112 for the data transmissions from the serving base station 122. The corresponding signal strength level such as a signal-to-interference ratio of the received data transmissions may fail to meet QoS requirements at the mobile device 112. In this regard, the mobile device 112 may utilize internal receiver processing to identify signal strength or power received from the serving base station 122 out of the total received power coming from neighboring base stations 124, 126 and other sources of interference. For example, various network orthogonalization techniques such as, for example, CDMA spreading codes and/or OFDM randomization codes may be utilized to filter or calculate the signal strength or power from the serving base station 122 out of the total received power coming from neighboring base stations 124, 126 and other sources of interference.

The mobile device 112 may be configured to utilize Smart antenna technology with beamforming techniques to mitigate interferences from the neighboring base stations 124-126. The mobile device 112 may be coupled to a receiver antenna array 113, which comprises a plurality of receive antennas for downlink reception. Depending on system configuration and/or device capabilities, fixed receiver antenna patterns or adaptive receiver antenna patterns may be implemented at the receiver antenna array 113. A fixed receiver antenna pattern utilized in the receiver antenna array 113 may be determined based on a device type that may be associated with the mobile device 112. An adaptive receiver antenna pattern utilized in the receiver antenna array 113 may be formed or determined via active steering with complex antenna weight vectors that may be estimated or calculated dynamically. In this regard, for a given orientation of the mobile device 112, a receiver antenna pattern utilized in the receiver antenna array 113 may be adaptive to the received data transmissions from the serving base station 122. For example, a receiver antenna pattern may be selected for the receiver antenna array 113 such that, for a given mobile orientation, the signal strength level measured at the mobile device 112 for the data transmissions from the serving base station 122 is maximized in the direction of the serving base station 122 and the undesired signal components, namely, interferences, radiated from the neighboring base stations 124-126 to the mobile device 112 are minimized. In this regard, the mobile device 112 may be operable to perform a receiver beamforming process on the data transmission received via the receiver antenna array 113 with the selected receiver antenna pattern.

The mobile device 122 may be operable to calculate or measure a complex antenna weight vector corresponding to the selected receiver antenna pattern for a receiver beamforming process. The calculated complex antenna weight vector may place nulls into the directions of the neighboring base stations 124-126 and form a main beam directed towards the serving base station 122. The calculated complex antenna weight vector may be applied to weight associated incoming beams of the received data transmissions. The resulting weighted incoming beams may be combined for decoding. The mobile device 122 may be operable to track and/or calculate the signal strength of the combined beam to generate beamforming signal strength measurements.

In an exemplary embodiment of the invention, the serving base station 122 may be initially located via a plurality of associated mobile devices. In this regard, the mobile device 112 may be operable to compensate signal strength measurements on the received data transmissions in three-dimensional space based on corresponding transmitter and/or receiver antenna pattern, and/or corresponding mobile orientation information. The mobile device 112 may estimate relative distances between the mobile device 112 and the serving base station 122 based on the compensated signal strength measurements. The estimated relative distances may be modeled or expressed as a function of the azimuth and elevation angles. In this regard, the mobile device 112 may be operable to fit the signal strength measurements to the desired model or function so as to refine the estimated relative distances. Location information for the serving base station 122 and/or the mobile device 112 may be improved or refined based on the refined relative distances. The mobile device 112 may be operable to communicate the refined location information for the serving base station 122 and/or the mobile device 112 to the location server 140 to build the reference database 142.

In another exemplary embodiment of the invention, the serving base station 122 may be located via the location server 140. In this regard, the mobile device 112 may be configured to transmit or communicate the signal strength measurements, corresponding transmitter and/or receiver antenna patterns, and/or mobile orientation information to the location server 140. In this regard, the transmitted signal strength measurements may be compensated in three-dimensional space at the location server 140 based on corresponding transmitter and/or receiver antenna pattern, and/or corresponding mobile orientation information. Relative distances between the mobile device 112 and the serving base station 122 may be estimated based on the compensated signal strength measurements. The estimated relative distances may be modeled or expressed as a function of the azimuth and elevation angles. In this regard, the relative distances between the mobile device 112 and the serving base station 122 may be refined at the location server 140 by fitting the signal strength measurements to the desired model or function. Location information for the serving base station 122 and/or the mobile device 112 may be improved or refined based on the refined relative distances.

Depending on device capabilities, the mobile device 112 may be operable to communicate with the mobile core network 130 using, for example, CDMA, GSM, UMTS, LTE and/or WiMAX access technologies.

A base station such as the serving base station 122 may comprise suitable logic, circuitry, interfaces and/or code that are operable to manage and schedule communication resources in an uplink direction and/or downlink direction to users of various mobile devices such as the mobile devices 112-116. The serving base station 122 may be coupled to a transmitter antenna array 122a, which comprises a plurality of transmit antennas utilized for downlink transmission. Depending on system configuration and/or device capabilities, fixed antenna patterns or adaptive antenna patterns may be utilized in the transmitter antenna array 122a.

The serving base station 122 may be operable to communicate radio frequency signals with the mobile devices 112-116 using air interface protocols specified in, for example, CDMA, GSM, UMTS, LTE and/or WiMAX radio access networks. The communicated radio signals may comprise data transmissions of various services such as a LBS provided by the mobile core network 130. In this regard, location information such as the location of the serving base station 122 may be required for LBS applications such as location based access control. The location of the serving base station 122 may be provided by the location server 140. In this regard, the location of the serving base station 122 may be determined and/or refined by the location server 140 based on signal strength measurements, corresponding transmitter and/or receiver antenna patterns, and/or mobile orientation information provided by a plurality of mobile devices within the coverage area of the serving base station 122.

The mobile core network 130 may comprise suitable logic, circuitry, interfaces and/or code that are operable to interface various access networks such as, for example, a CDMA network, a UMTS network and/or a WiMAX network, with external data networks such as packet data networks (PDNs). The mobile core network 130 may be operable to provide various data services, which are provided by external data networks, to users such as, for example, the mobile devices 112-116. In instances where a LBS application is provided to a user of the mobile device 112, the mobile core network 130 may communicate with the location server 140 for location information required for the LBS application.

The location server 140 may comprise suitable logic, circuitry, interfaces and/or code that are operable to access the satellite reference network (SRN) 150 to collect GNSS satellite data by tracking GNSS constellations through the SRN 150. The location server 140 may be operable to utilize the collected GNSS satellite data to generate GNSS assistance data (A-GNSS data) comprising, for example, ephemeris data, LTO data, reference positions and/or time information. The location server 150 may be operable to collect and/or retrieve location information of interest from a plurality of users. For example, the location server 140 may track location information of the serving base station 122 from a plurality of mobile devices such as the mobile devices 112-116 in the coverage area of the serving base station 122.

In an exemplary embodiment of the invention, the location server 140 may be operable to receive initial locations for the serving base station 122 from a plurality of mobile devices such as the mobile devices 112-116 within the coverage area of the serving base station 122. An initial location for the serving base station 122 may be determined by a mobile device such as the mobile device 112 based on signal strength measurements, corresponding transmitter and/or receiver antenna patterns, and/or mobile orientation information. The location server 140 may be operable to determine a final location for the serving base station 122 based on the received initial locations provided by the plurality of associated mobile devices. The determined final location of the serving base station 122 may be stored into the reference database 142, where it may be shared among a plurality of communication devices such as the mobile devices 112-116 to improve LBS performance.

In another exemplary embodiment of the invention, the serving base station 122 may be located via the location server 140. In other words, the location server 140 may be configured to calculate or determine both initial locations projected from each associated mobile device and a final location for the serving base station 122. In this regard, the location server 140 may be operable to receive, from a plurality of mobile devices within a coverage area of the serving base station 122, signal strength measurements, corresponding transmitter and/or receiver antenna patterns, and/or mobile orientation information. The location server 140 may be configured to provide compensation for the received signal strength measurements in three-dimensional space based on corresponding transmitter and/or receiver antenna pattern, and/or corresponding mobile orientation information. Relative distances between each of the mobile devices and the serving base station 122 may be estimated based on the compensated signal strength measurements. The estimated relative distances may be modeled or expressed as a function of, for example, the azimuth and elevation angles. The relative distances between each mobile device and the serving base station 122 may be refined by fitting the signal strength measurements to the desired model or function. Location information for the serving base station 122 and/or each mobile device may be improved or refined based on the refined relative distances. The refined location information for the serving base station 122 and/or each mobile device may be stored into the reference database 142, where it may be shared among a plurality of users.

The SRN 150 may comprise suitable logic, circuitry, interfaces and/or code that are operable to acquire, collect and/or distribute data for GNSS satellites on a continuous basis. The SRN 150 may comprise a plurality of GNSS reference tracking stations located around the world to provide constant A-GNSS coverage in both a home network and/or any visited network.

The GNSS satellites 162-166 may comprise suitable logic, circuitry, interfaces and/or code that may be operable to generate and broadcast satellite navigational information. The broadcast satellite navigational information may be collected by the SRN 150 to be utilized by the location server 140 to enhance LBS performance. The GNSS satellites 162-166 may comprise GPS, Galileo, and/or GLONASS satellites.

In an exemplary operation, mobile devices such as the mobile device 112 may be operable to receive data transmissions of services from the mobile core network 130 via the serving base station 122. The received data transmissions may comprise desired signal components from the serving base station 112 and interferences from the neighboring base stations 124-126 as well as thermal noise. To mitigate interferences, the mobile device 112 may be operable to utilize Smart antenna technology with beamforming techniques for the downlink reception. Depending on system configuration and/or device capabilities, fixed antenna patterns or adaptive antenna patterns may be implemented at the serving base station 122 and/or the mobile device 112.

In instances where the serving base station 122 is initially located via a plurality of associated mobile devices, the mobile device 112 may be operable to compensate signal strength measurements on the received data transmissions in three-dimensional space based on corresponding transmitter and/or receiver antenna pattern, and/or corresponding mobile orientation information. Relative distances between the mobile device 112 and the serving base station 122 may be estimated based on the compensated signal strength measurements. The mobile device 112 may be operable to refine the estimated relative distances by fitting the signal strength measurements to a function of the azimuth and elevation angles. A location for the serving base station 122 and/or the mobile device 112 may be calculated or refined based on the refined relative distances. The refined location for the serving base station 122 and/or the mobile device 112 may be communicated to the location server 140 where it may be utilized to build the reference database 142.

In instances where the serving base station 122 is located via the location server 140, the location server 140 may be operable to receive, from a plurality of mobile devices within a coverage area of the serving base station 122, signal strength measurements, corresponding transmitter and/or receiver antenna patterns, and/or mobile orientation information. The received signal strength measurements may be compensated in three-dimensional space based on corresponding transmitter and/or receiver antenna pattern, and/or corresponding mobile orientation information. The location server 140 may be operable to estimate relative distances between each mobile device mobile device and the serving base station 122 utilizing the compensated signal strength measurements. A location for the serving base station 122 and/or each mobile device may be refined based on the refined relative distances whenever needed. The location server 140 may store the refined location for the serving base station 122 and/or each mobile device in the reference database 142, where it may be shared among a plurality of users for LBS applications.

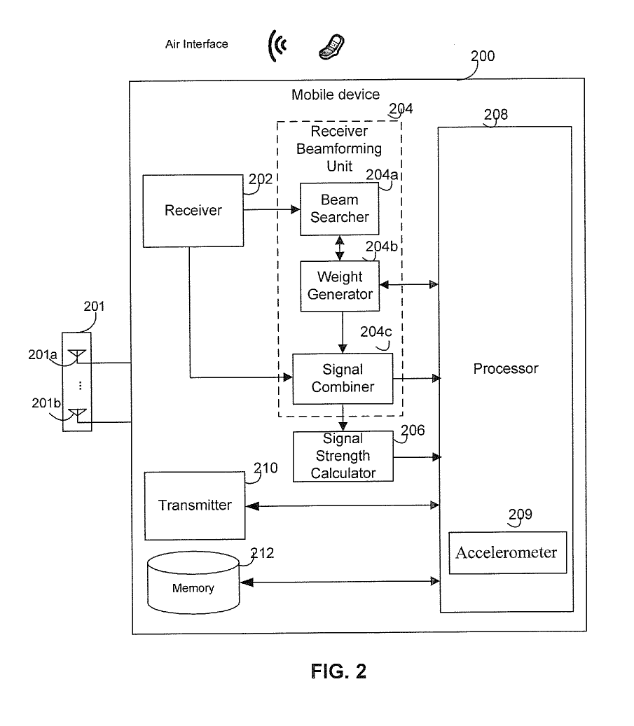

FIG. 2 is a block diagram illustrating an exemplary mobile device that is operable to refine location information utilizing an adaptive receiver antenna array, in accordance with an embodiment of the invention. Referring to FIG. 2, there is shown a mobile device 200. The mobile device 200 comprises a receiver antenna array 201, a receiver 202, a receiver beamforming unit 204, a signal strength calculator 206, a processor 208 comprising an accelerometer 209, a transmitter 210 and a memory 212. The receiver beamforming unit 204 comprises a beam searcher 204a, a weight generator 204b and a signal combiner 204c.

The receiver antenna array 201 may comprise suitable logic, circuitry, interfaces and/or code that may be operable to generate antenna beam patterns to form a plurality of beams. The plurality of beams may be arranged to orient in specific directions such as a direction towards to the serving base station 122. The receiver antenna array 201 may be operable to detect and receive incoming beams falling within an area covered by the generated plurality of beams. In this regard, the receiver antenna array 201 may be configured to generate antenna beam patterns adaptive to incoming beams so that the signal strength of the incoming beams related to the serving base station 122 is optimized. For example, the receiver antenna array 201 may be operable to adjust antenna beam patterns to maximize the signal strength of the incoming beams in the direction towards to the serving base station 122 and to reduce interferences from nearby cells such as the neighboring base stations 124-126.

The receiver 202 may comprise suitable logic, circuitry, interfaces and/or code that may be operable to receive data transmissions from the serving base station 122 utilizing various radio access technologies such as CDMA, GSM, UMTS, LTE and/or WiMAX. The received data transmissions may comprise services provided by the mobile core network 130. In instances where the mobile device 200 is moving closer to the neighboring base stations 124-126, interferences from the neighboring base stations 124-126 may become unacceptable at the mobile device 112. In this regard, the receiver 202 may communicate incoming beams with the receiver beamforming unit 206 so that signals from the serving base station 122 may be reconstructed.

The receiver beamforming unit 204 may comprise suitable logic, circuitry, interfaces and/or code that may be operable to spatially process incoming beams received via the receiver antenna array 201. The incoming beams may be complex weighted. More specifically, the receiver beamforming unit 204 may apply appropriate phase shifting and amplitude scaling on the incoming beams to maximize signal to interference ratio for corresponding data transmissions from the serving base station 122. The weighted incoming beams are combined for further processing such as decoding.

The beam searcher 204a may comprise suitable logic, circuitry, interfaces and/or code that may be operable to search incoming beams to determine, for a given mobile orientation, a main central angle of the incoming beams that covers the serving base station 122. The main central angle of the incoming beams may be determined by maximizing the signal strength of the incoming beams in the direction towards to the serving base station 122 and nullifying interferences from the neighboring base stations 124-126. The beam searcher 206a may communicate the determined main central angle to the weight generator 204b.

The weight generator 204b may comprise suitable logic, circuitry, interfaces and/or code that may be operable to generate an antenna beam pattern based on the determined main central angle. A complex antenna weight vector may be calculated based on the generated antenna beam pattern. The calculated complex antenna weight vector comprises a plurality of complex weights corresponding to the incoming beams from the receiver 202. The weight generator 204b may communicate the generated antenna beam pattern to the processor 208. The calculated complex antenna weight vector may be communicated with the signal combiner 204c for signal combining.

The signal combiner 204c may comprise suitable logic, circuitry, interfaces and/or code that may be operable to weight the incoming beams utilizing the calculated complex antenna weight vector from the weight generator 204b. The signal combiner 204c may be operable to combine the resulting weighted beams for decoding.

The signal strength calculator 206 may comprise suitable logic, circuitry, interfaces and/or code that may be operable to calculate the signal strength of the combined beam from the signal combiner 204c to provide beamforming signal strength measurements to the processor 208. The signal strength calculator 206 may be operable to calculate desired signal strength of the serving base station 112 out of the total received power comprising additional power from the neighboring base stations 124-126 as well as interference from other sources.

The processor 208 may comprise suitable logic, circuitry, interfaces and/or code that may be operable to manage and/or control operations of associated device components such as the receiver beamforming unit 204a. For example, the accelerometer 209 may provide device orientation information to the processor 208. The processor 208 may be operable to utilize the device orientation information to refine an antenna beam pattern, relative to the serving base station 122, which may be utilized for receiver beamforming processing. The processor 208 may be operable to instruct the beam searcher 204a and/or the weight generator 204b to adjust antenna beam patterns according to the device orientation information provided by the accelerometer 209. The processor 208 may be operable to decode the combined beam from the signal strength combiner 204c for services of interest.

Depending on implementation, the processor 208 may be operable to utilize signal strength measurements and corresponding transmitter and/or receiver beamforming information to determine location information for the serving base station 122 and/or the mobile device 200. For example, the processor 204 may be operable to determine a specific direction to place the serving base station 122 based on a receiver antenna beam pattern generated by the weight generator 204b. The serving base station 122 may be located in the determined specific direction based on corresponding beamforming signal strength measurements provided by the signal strength calculator 206. In this regard, the distance between the mobile device 200 and the serving base station 122 is inversely proportional to the beamforming signal strength measurements in the determined direction. The resulting location information of the serving base station 122 and/or the mobile device 200 may be transmitted to the location server 140 to build the reference database 142.

In instances where the serving base station 122 is located via the location server 140, the processor 208 may be configured to transmit or communicate signal strength measurements, corresponding transmitter and/or receiver antenna patterns, and/or mobile orientation information, via the transmitter 210, to the location server 140 for locating the serving base station 122 and/or the mobile device 200.

The transmitter 210 may comprise suitable logic, circuitry, interfaces and/or code that may be operable to facilitate signals to be transmitted to the serving base station 122.

The memory 212 may comprise suitable logic, circuitry, interfaces and/or code that may be operable to store information such as executable instructions and data that may be utilized by the processor 208 and/or other device components such as, for example, the receiver beamforming unit 204. The memory 212 may comprise RAM, ROM, low latency nonvolatile memory such as flash memory and/or other suitable electronic data storage.

In an exemplary operation, the processor 208 may be operable to control operations of, for example, the receiver 202 and/or the receiver beamforming unit 204. The receiver 202 may be operable to receive data transmissions from the serving base station 122 via the receiver antenna array 201. Corresponding incoming beams of the received data transmissions are spatially processed by the receiver beamforming unit 204. The beam searcher 204a may be operable to place a main central angle of the receiver antenna array 201 towards to the direction of the serving base station 122. An antenna beam pattern may be determined or refined by the weight generator 204b based on the main central angle of the receiver antenna array 201. The antenna beam pattern may be refined based on the device orientation information from the accelerometer 209. A complex antenna weighting vector may be generated based on the refined antenna beam pattern. The generated complex antenna weighting vector may be applied to weight the incoming beams. The resulting weighted incoming beams may be combined via the signal combiner 204c. The combined beam may be communicated to the processor 208 for decoding. The signal strength of the combined beam may be calculated via the signal strength calculator 206 to generate beamforming signal strength measurements. The generated beamforming signal strength measurements may be communicated with the processor 208 for refining a location estimate for the mobile device 200 as well as locating the serving base station 122.

In instances where the serving base station 122 is initially located via associated mobile devices, the processor 208 may be operable to place the serving base station 122 in a specific direction based on a corresponding antenna beam pattern used in receiver beamforming. The serving base station 122 may be located in the specific direction based on beamforming signal strength measurements, corresponding transmitter and/or receiver antenna pattern, and/or mobile orientation information. The processor 208 may be operable to communicate the resulting location information of the serving base station 122 via the transmitter 210 to the location server 140 to build the reference database 142.

In instances where the serving base station 122 is located via the location server 140, the host processor 206 may transmit or communicate beamforming signal strength measurements, corresponding transmitter and/or receiver antenna patterns, and/or mobile orientation information, via the transmitter 210, to the location server 140. The location server 130 may determine a location for the serving base station 122 and/or the mobile device 200 based on received signal strength measurements, corresponding transmitter and/or receiver antenna patterns, and/or mobile orientation information.

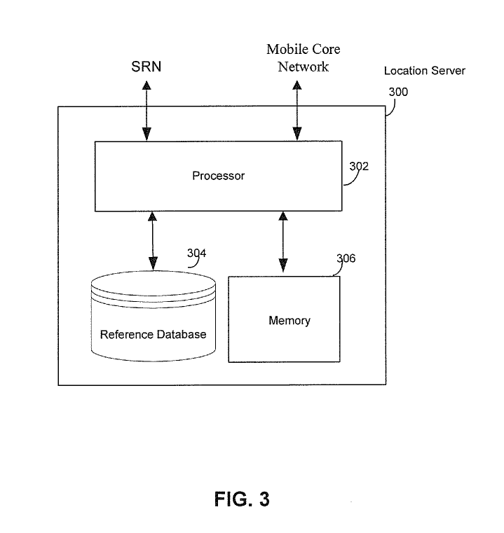

FIG. 3 is a block diagram illustrating an exemplary location server that is operable to refine a location for a base station and/or a mobile device based on signal strength measurements and corresponding transmitter and/or receiver antenna pattern, in accordance with an embodiment of the invention. Referring to FIG. 3, there is shown a location server 300. The location server 300 may comprise a processor 302, a reference database 304 and a memory 306.

The processor 302 may comprise suitable logic, circuitry, interfaces and/or code that may be operable to manage and/or control operations of the reference database 304 and the memory 306. The processor 302 may be operable to communicate with the satellite reference network (SRN) 150 so as to collect GNSS satellite data by tracking GNSS constellations through the SRN 150. The processor 302 may utilize the collected GNSS satellite data to build the reference database 304, which may be coupled internally or externally to the location server 300. The processor 302 may be operable to retrieve location information from users such as the mobile devices 112-116. The processor 302 may also track or collect information that may be utilized for locating an object of interest such as the serving base station 122 of the mobile devices 112-116. In instances where the serving base station 122 is located by the location server 300, the processor 302 may be operable to retrieve or receive signal strength measurements, corresponding transmitter and/or receiver antenna patterns, and/or mobile orientation information from a plurality of mobile devices in a coverage area of the serving base station 122.

The received signal strength measurements may be compensated in three-dimensional space based on corresponding transmitter and/or receiver antenna pattern, and/or corresponding mobile orientation information. The processor 302 may be operable to estimate or determine relative distances between each mobile device mobile device and the serving base station 122 based on the corresponding compensated signal strength measurements. The estimated relative distances may be expressed as a function of the azimuth and elevation angles. The processor 302 may refine the relative distances between each mobile device and the serving base station 122 by fitting the received signal strength measurements to the desired model or function. A location for the serving base station 122 and/or each mobile device may be improved or refined based on the refined relative distances whenever needed. The processor 302 may store the refined location for the serving base station 122 and/or each mobile device into the reference database 304, where it may be shared among a plurality of communication devices.

The reference database 304 may comprise suitable logic, circuitry, interfaces and/or code that may be operable to store location information of associated communication devices such as the serving base station 122 of the mobile devices 112-116. The stored location information may be provided to communication devices to support LBS applications such as location-based access control. The location database 304 may be operable to manage and update the stored location information when need, aperiodically or periodically. For example, the reference database 304 may be operable to refine the stored location information based on information on corresponding transmitter and/or receiver antenna patterns, aw well as mobile orientation information.

The memory 306 may comprise suitable logic, circuitry, interfaces and/or code that may be operable to store information such as executable instructions and data that may be utilized by the processor 302 and/or other associated component units such as, for example, the reference database 304. The memory 306 may comprise RAM, ROM, low latency nonvolatile memory such as flash memory and/or other suitable electronic data storage.

In an exemplary operation, the processor 302 may be operable to collect GNSS satellite data through the SRN 150 to build the reference database 304. The processor 302 may track or collect information required for locating a base station such as the serving base station 122 of the mobile devices 112-116. In this regard, the processor 302 may be operable to receive signal strength measurements and corresponding transmitter and/or receiver beamforming information, and/or mobile orientation information from a plurality of mobile devices served by the serving base station 122. The received signal strength measurements may be compensated in three-dimensional space based on corresponding transmitter and/or receiver antenna pattern, and/or corresponding mobile orientation information. The relative distances between a mobile device such as the mobile device 112 and the serving base station 122 may be determined based on the corresponding compensated signal strength measurements. The processor 302 may be configured to model the estimated relative distances as a function of the azimuth and elevation angles. In this regard, the received signal strength measurements may be fit to the desired model or function so as to refine the relative distances between the mobile device 112 and the serving base station 122. The processor 302 may be operable to calculate or determine a location for the serving base station 122 and/or the mobile device 112 based on the corresponding refined relative distances whenever needed. The determined location of the serving base station 122 and/or the mobile device 112 may be stored into the reference database 304, where it may be shared among a plurality of communication devices such as the mobile devices 112-119 to improve LBS performance.

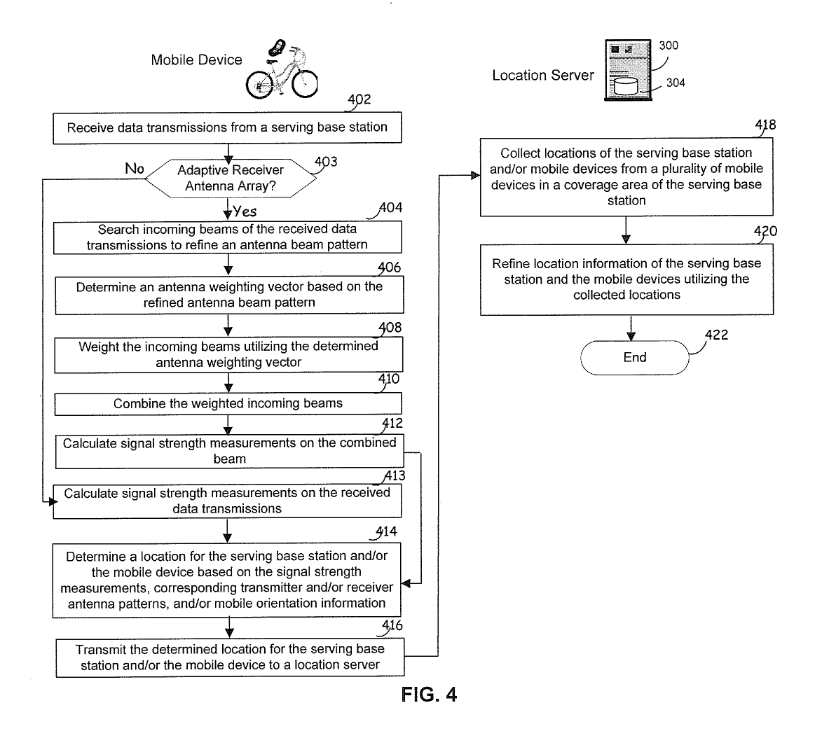

FIG. 4 is a flow chart illustrating an exemplary procedure that is utilized by a mobile device to locate a base station utilizing signal strength measurements and corresponding transmitter and/or receiver antenna pattern, in accordance with an embodiment of the invention. Referring to FIG. 4, the exemplary steps may start with step 402. In step 402, a mobile device such as the mobile device 112 may be operable to receive data transmissions from one or more antennas in the transmitter antenna array 122a of the serving base station 122. In step 403, it may be determined whether an adaptive receiver antenna array is implemented at the mobile device 112. In instances where an adaptive receiver antenna array is implemented at the mobile device 112, then in step 404, the mobile device 112 may be operable to search corresponding incoming beams of the data transmissions to determine or refine an antenna beam pattern for downlink reception for a given mobile orientation.

In step 406, the mobile device 112 may be operable to determine an antenna weighting vector via the weight generator 204b for the determined antenna beam pattern. In step 408, the incoming beams of the received data transmissions are weighted utilizing the determined antenna weighting vector. In step 410, the weighted incoming beams are combined for further processing. In step 412, the signal strength of the combined beam is calculated for the received data transmissions utilizing the combined beam. The exemplary steps continue in step 414. In step 414, a location for the serving base station 122 and/or the mobile device 200 may be determined based on the signal strength measurements, corresponding transmitter and/or receiver antenna patterns, and/or mobile orientation information.

In step 416, the mobile device 112 may be operable to transmit the determined location of the serving base station 122 and/or the mobile device 112 to the location server 300. In step 418, the location server 300 may be operable to collect location information for the serving base station 122 and mobile devices such as the mobile device 112 from a plurality of mobile devices in a coverage area of the serving base station 122. In step 420, the location server 300 may refine location information for the serving base station 122 and/or the mobile device 112 utilizing the collected locations. For example, the mean or a weighted average of the collected locations for the serving base station 122 may be used as a final location for the serving base station 122. The exemplary steps may end in step 422.

In step 403, in instances where an adaptive receiver antenna array is not implemented at the mobile device 112, then the exemplary steps may continue in step 413. In step 413, the mobile device 112 may calculate signal strength measurements on the received data transmissions. The exemplary steps may continue in step 414.

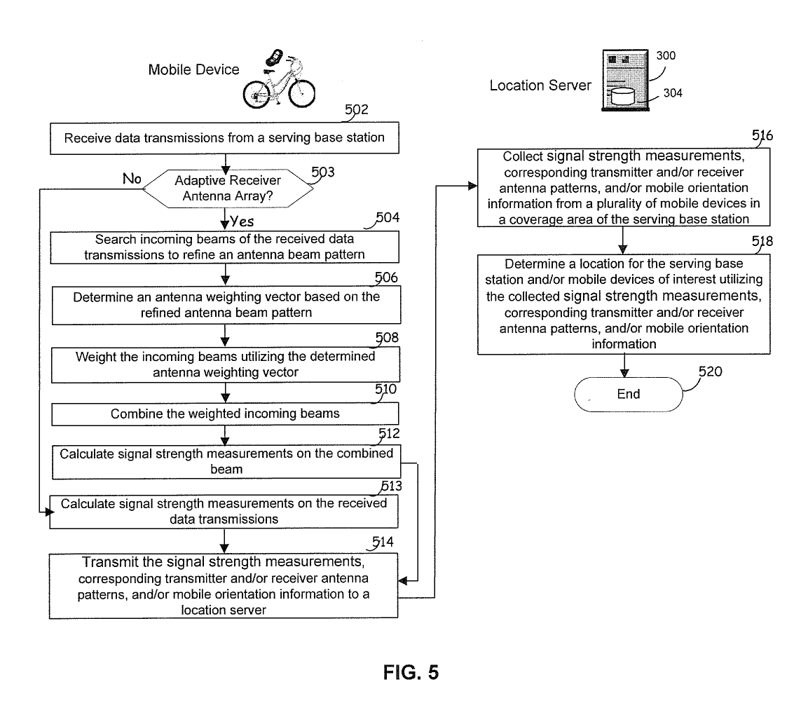

FIG. 5 is a flow chart illustrating an exemplary procedure that is utilized by a location server to locate a base station and/or a mobile device based on signal strength measurements and corresponding transmitter and/or receiver antenna pattern, in accordance with an embodiment of the invention. Referring to FIG. 5, the exemplary steps may start with step 502. The exemplary steps 502-513 are the same as steps 402-412 in FIG. 4. In step 514, the mobile device 200 may be operable to transmit the signal strength measurements, corresponding transmitter and/or receiver antenna patterns, and/or mobile orientation information to a location server to the location server 300. In step 516, the location server 300 may be operable to collect signal strength measurements, corresponding transmitter and/or receiver antenna patterns, and/or mobile orientation information from a plurality of mobile devices in a coverage area of the serving base station 122. In step 518, the location server 300 may be operable to determine a location for the serving base station and/or mobile devices of interest, for example, the mobile device 112, utilizing the corresponding collected signal strength measurements, transmitter and/or receiver antenna patterns, and/or mobile orientation information. The exemplary steps may end in step 520.

In various exemplary aspects of the method and system for refining a location of a base station and/or a mobile device based on signal strength measurements and corresponding transmitter and/or receiver antenna pattern, a mobile device such as the mobile device 200 coupled with the receiver antenna array 201 may be operable to receive data transmissions, via the receiver antenna array 201, from one or more antennas in a transmitter antenna array of a serving base station such as the serving base station 122. The mobile device 200 may be operable to determine relative distances, with respect to the serving base station 122, associated with signal strength measurements for the received data transmissions. The signal strength measurements may be compensated, at the mobile device 200 and/or a remote location server such as the location server 300, in three-dimensional space based on corresponding transmitter and/or receiver antenna pattern, and/or mobile orientation information. Depending on system configuration and/or device capabilities, the transmitter antenna array 122a and/or the receiver antenna array 201 may be configured to a fixed antenna array and/or an adaptive antenna array, as described in FIGS. 2, 4 and 5.

The relative distances between the mobile device 200 and the serving base station 122 may be estimated based on the signal strength measurements, the corresponding transmitter antenna pattern utilized in the transmitter antenna array 122a and/or receiver antenna pattern utilized in the receiver antenna array 201, and/or mobile orientation information provided by, for example, the accelerometer 209. The estimated relative distances between the mobile device 200 and the serving base station 122 may be modeled or expressed as a function of the azimuth and elevation angles. In this regard, the signal strength measurements may be utilized to refine the estimated relative distances by fitting to the desired model or function. The accuracy of location information of the serving base station 122 and/or the mobile device 200 may be improved based on the refined relative distances. The refined location information of the serving base station 122 and/or the mobile device 200 may be communicated to the location server 300 to support LBS applications.

Depending on system configuration, the mobile device 200 may be operable to transmit or communicate to the location server 300 with the signal strength measurements, corresponding transmitter and/or receiver antenna pattern, and/or the mobile orientation information. In this regard, the location server 300 is operable to receive or retrieve signal strength measurements, corresponding transmitter and/or receiver antenna patterns, and/or corresponding mobile orientation information from a plurality of mobile devices such as the mobile devices 112-116 in a coverage area served by the serving base station 122. The received signal strength measurements may be compensated in three-dimensional space based on the received corresponding transmitter and/or receiver antenna patterns, and/or the received corresponding mobile orientation information. The location server 300 may be operable to estimate relative distances between each mobile device and the serving base station 122 based on the compensated signal strength measurements. Location information for the serving base station 122 and/or each mobile device may be refined based on the estimated corresponding relative distances whenever needed.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for refining a location of a base station and/or a mobile device based on signal strength measurements and corresponding transmitter and/or receiver antenna pattern.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by one or more processors and/or circuits in a mobile device comprising a receiver antenna array:
receiving, via said receiver antenna array, data transmissions from one or more antennas in a transmitter antenna array of a serving base station; and
determining relative distances, between said mobile device and said serving base station, associated with signal strength measurements on said received data transmissions, wherein said signal strength measurements are compensated in three-dimensional space based corresponding antenna patterns utilized in said transmitter antenna array and/or said receiver antenna array, and/or mobile orientation information.

2. The method according to claim 1, wherein said receiver antenna array and/or said transmitter antenna array comprise a fixed antenna array and/or an adaptive antenna array.

3. The method according to claim 2, comprising estimating said relative distances between said mobile device and said serving base station based on said signal strength measurements, said corresponding antenna patterns, and/or said mobile orientation information.

4. The method according to claim 3, comprising modeling said estimated relative distances between said mobile device and said serving base station as a function of azimuth and elevation angles.

5. The method according to claim 4, comprising refining said estimated relative distances by fitting said signal strength measurements to said function of azimuth and elevation angles.

6. The method according to claim 5, comprising refining location information for said serving base station and/or said mobile device based on said refined relative distances; and transmitting said refined location information for said serving base station and/or said mobile device to a remote location server.

7. The method according to claim 6, wherein said remote location server receives signal strength measurements, corresponding transmitter and/or receiver antenna patterns, and/or corresponding mobile orientation information from a plurality of mobile devices in a coverage area served by said serving base station.

8. The method according to claim 7, wherein said remote location server compensates said received signal strength measurements in three-dimensional space based on said received corresponding transmitter and/or receiver antenna patterns, and/or said received corresponding mobile orientation information.

9. The method according to claim 8, wherein said remote location server estimates relative distances between each mobile device and said serving base station based on said compensated signal strength measurements.

10. The method according to claim 9, wherein said remote location server refines location information for said serving base station and/or said each mobile device based on said estimated relative distances.

11. A system for communication, the system comprising:
one or more processors and/or circuits for use in a mobile device comprising a receiver antenna array, said one or more processors and/or circuits being operable to:
receive, via said receiver antenna array, data transmissions from one or more antennas in a transmitter antenna array of a serving base station; and
determine relative distances, between said mobile device and said serving base station, associated with signal strength measurements on said received data transmissions, wherein said signal strength measurements are compensated in three-dimensional space based corresponding antenna patterns utilized in said transmitter antenna array and/or said receiver antenna array, and/or mobile orientation information.

12. The system according to claim 11, wherein said receiver antenna array and/or said transmitter antenna array comprise a fixed antenna array and/or an adaptive antenna array

13. The system according to claim 12, wherein said one or more processors and/or circuits are operable to estimate said relative distances between said mobile device and said serving base station based on said signal strength measurements, said corresponding antenna patterns, and/or said mobile orientation information.

14. The system according to claim 13, wherein said one or more processors and/or circuits are operable to model said estimated relative distances between said mobile device and said serving base station as a function of azimuth and elevation angles.

15. The system according to claim 14, wherein said one or more processors and/or circuits are operable to refine said estimated relative distances by fitting said signal strength measurements to said function of azimuth and elevation angles.

16. The system according to claim 15, wherein said one or more processors and/or circuits are operable to refine location information for said serving base station and/or said mobile device based on said refined relative distances; and transmitting said refined location information for said serving base station and/or said mobile device to a remote location server.

17. The system according to claim 16, wherein said remote location server receives signal strength measurements, corresponding transmitter and/or receiver antenna patterns, and/or corresponding mobile orientation information from a plurality of mobile devices in a coverage area served by said serving base station.

18. The system according to claim 17, wherein said remote location server compensates said received signal strength measurements in three-dimensional space based on said received corresponding transmitter and/or receiver antenna patterns, and/or said received corresponding mobile orientation information.

19. The system according to claim 18, wherein said remote location server estimates relative distances between each mobile device and said serving base station based on said compensated signal strength measurements.

20. The system according to claim 19, wherein said remote location server refines location information for said serving base station and/or said each mobile device based on said estimated relative distances.
